(19) United States
(12) Patent Application Publication
(10) Pub. No.: US 2006/0127279 A1
(43) Pub. Date: Jun. 15, 2006

(54) Multifunction measuring instrument

(76) Inventors: Juhani Aalto, Turku (FI); Jukka Haaslahti, Turku (FI)

Correspondence Address: KUBOVCIK & KUBOVCIK, SUITE 710, 900 17TH STREET NW, WASHINGTON, DC, 20006, US

(21) Appl. No.: 10/522,796

(22) PCT Filed: Jul. 30, 2003
(86) PCT No.: PCT/FI03/00585

§ 371 Date: Dec. 15, 2005

(30) Foreign Application Priority Data
Jul. 30, 2002 (FI) 20021423

(51) Int. Cl. G01N 21/64

(52) U.S. Cl. 422/82.05; 422/82.08

(57) ABSTRACT

The object of the invention is a multifunction instrument (10 ) for measuring biochemical and medical samples, which are preferably placed into the wells (13) of the sample plates (12) and measured by a detector (20). The detector is movable with slide (26, 27) and guide (22, 23) elements so that a rotating device (14) can turn the detector into vertical position for liquid scintillation counting and/or luminescence counting. The second horizontal position and light path (30) is provided for fluorescence measuring with a light source (40) for excitation. Also an absorbance detector (50) is included.

### OBJECT OF THE INVENTION

The invention relates to a multifunction instrument for measuring biochemical and medical samples, which are preferably placed into the wells of the sample plates and measured by a detector, the instrument having means for moving the detector into two different positions for using at least two different light paths for measuring the samples.

### PRIOR ART

The known measuring devices are usually intended for one measuring process, as for example radioactive labels, luminescence, several types of fluorescence or absorption. Also multifunction measuring instruments have been made, typically involving either non-radioactive methods or radioactivity counting and luminescence. Instruments measuring both radioactive labels and fluorescence are not known to exist. The aim of the present invention is to solve the problems and provide a new multifunction instrument capable to measure all commonly used techniques

The document U.S. Pat. No. 6,191,852 presents an optical measuring system for detecting luminescence or fluorescence signals. In the device there is a glass-fiber taper element and an image sensor situated opposite the small end surface of the image sensor. The combination of the glass-fiber taper element and the image sensor is fitted on a fixed frame allowing it to pivot through 180° about a rotary spindle. In the first position a first microtitre plate is measured from the top and in the second position a second microtitre plate is measured from the bottom through the transparent bottom of the microtitre plate. The arrangement is not suitable for measuring radioactive labels by liquid scintillation counting because the decreasing cross-sectional area of the glass-fiber taper element will result a significant loss of light photons. The signal level is therefore highly reduced and under the minimum for liquid scintillation counting. The document U.S. Pat. No. 4,132,653 presents a polarization analyzer for vacuum ultraviolet and x-ray radiation. In the device the detector is pivotable 90° between two positions. In a first position the detector is placed in front of the mirror to detect the radiation Rᵢ incident on mirror, and in a second position detector is rotated 90° to detect the radiation Rᵣ reflected by mirror. The arrangement is suitable for the polarization analyzer because the strong beam of radiation is emerged for example from a monochromator or from a syncrothron. However, the arrangement is not suitable for measuring radioactive labels by liquid scintillation counting because the detector could not detect weak light photons emitted from a radioactive sample.

The aim of the present invention is to solve the above problems and provide a new multifunction instrument.

### SUMMARY OF THE INVENTION

The present invention may be briefly described and summarised that the multifunction instrument is provided with a device for moving the detector into the following two different positions for two different light paths:
in the first position for measuring radioactive labels by liquid scintillation counting the detector is placed close to the sample or sample well for receiving signals via the first light path without any light conducting components between the detector and the sample,
and in the second position for non-radioactive measuring, such as fluorescence measuring the detector is arranged to receive emitted light from the sample via the second light path, where is at least one optical component, such as a lens, mirror of a glass fiber between the detector and the sample.

### PREFERRED EMBODIMENTS

According to a preferred embodiment of the invention the multifunction instrument is provided with a rotating device for rotating the detector in two different positions for the said two different light paths.

According to a second preferred embodiment of the invention in the first position the detector the first light path is provided for liquid scintillation counting and/or luminescence counting, and that the second light path is provided for fluorescence measuring.

According to a third preferred embodiment of the invention the multifunction instrument has a light source provided for excitation light with the second light path for fluorescence measuring.

According to a fourth preferred embodiment of the invention the multifunction instrument is provided with an absorbance detector to be used with the said light source.

According to a fifth preferred embodiment of the invention the detector is provided with slide and guide elements, the rotating device is provided to turn the detector into vertical position for liquid scintillation measuring and/or luminescence counting above the sample plate, and that the rotating device is provided to turn the detector into horizontal position for fluorescence measuring via the second light path.

The multifunction instrument according to the invention can measure radioactive labels by using liquid scintillation counting and/or luminescence counting process and also non-radioactive labels by using fluorescence process. For both of these measurements can be used the same rotating detector, a photo multiplier tube above the sample.

The second photo multiplier tube under the sample, primarily used in liquid scintillation counting for better efficiency, can also be used for absorbance measuring. However, the absorbance measurements can also be carried out with a separate absorbance detector, if there is no photo multiplier tube under the sample.

In that case the same light source can be used in the excitation of fluorescence measurement and in the absorbance measurement.

In liquid scintillation counting the radioactive labels such as tritium H³, radiocarbon C¹⁴, phosphor P³², iodine I¹²⁵ and other beta emitting isotopes can be measured.

In fluorescence measurements the excitation light and the emission light have different wavelengths. The excitation light pulse of about 1 μs is partly in UV area having wavelength of 240-500 nm. The light emitted from the sample label is visible light having wavelength of 400-650 nm. The prompt, time-resolved and polarization processes can be used.

According to a further embodiment of the invention
the detector is provided with slide and guide elements for turning the detector into the said two positions,
the rotating device is provided to turn the detector into the first position or the vertical position for liquid scintillation measuring and/or luminescence counting above the sample plate,
and the rotating device is provided to turn the detector into the second position or the horizontal position for fluorescence measuring via the second light path.

According to a further embodiment of the invention the vertical first position of the detector the detector is used for liquid scintillation counting and placed above the sample well without any intermediate components.

According to a further embodiment of the invention in the vertical first position a cover plate provided with an aperture is placed between the detector and the sample well for guiding the light from the sample through the aperture to the detector.

According to a further embodiment of the invention
the cover plate is a slide element provided with at least two apertures of different size diameter,
and the slide element can be moved in horizontal direction for placing any of the apertures above the sample well to be measured.

Due to the different size measuring apertures in the slide element the different size of sample wells can be measured. For most common diameter of wells, 24 and 96 wells, to be measured there is an appropriate aperture in the cover plate.

According to a further embodiment of the invention at least one aperture in the slide element is funnel shaped so that the aperture end of smaller diameter facing the sample well substantially fits the size of the diameter of the sample well. The opposite aperture end of larger diameter is facing the detector. The arrangement ensures that the detector detects all light photons emitted from the radioactive sample.

### BRIEF DESCRIPTION OF THE DRAWINGS

An embodiment of the invention is described in the following by means of an example with reference to the appended drawings. However, the present invention should not be construed to be limited thereto. In the drawings

FIG. 1 shows a cross-sectional view of a multifunction instrument.

FIG. 2 corresponds to FIG. 1 and shows the multifunction instrument in a second measuring position.

FIG. 3 shows another cross-sectional view of a multifunction instrument.

### DETAILED DESCRIPTION OF THE PREFERRED EMBODIMENT RELATIVE TO THE DRAWINGS

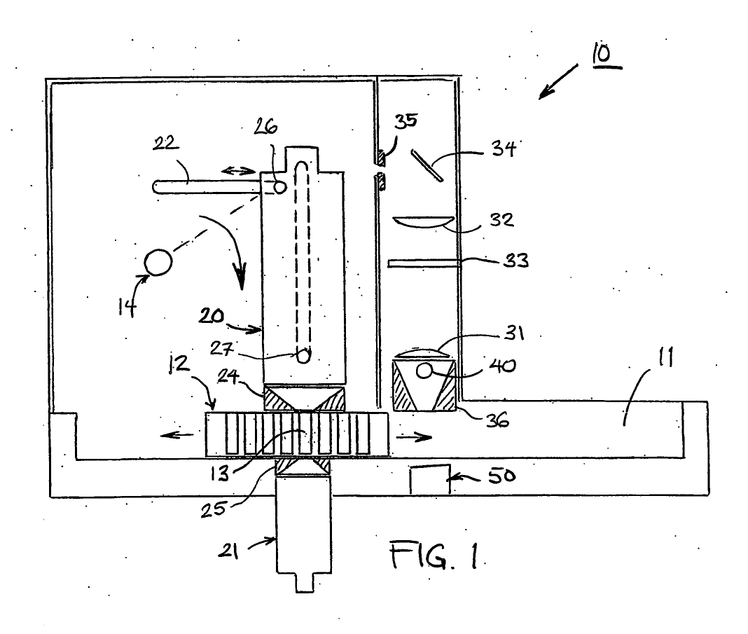

In FIG. 1 there is a multifunction instrument 10, which has a transfer unit 11 for moving sample plates 12. The sample to be measured is placed into a well 13 of the sample plate 12. In the multifunction instrument 10 of FIG. 1, which is an embodiment of the invention, there are two measuring detectors. The first measuring detector 20, which is a photo multiplier tube, is located above the sample well 13. It can be used e.g. as a liquid scintillation counter for measuring low energy radiation emitting samples and/or luminescence counting. For double detector measuring process in the multifunction instrument 10 there is optionally the second measuring detector 21, which is also a photo multiplier tube and locating under the sample well 13.

For measuring different kind of sample plates 12 there are cover plates 24 and 25 between the sample plate 12 and the detectors 20 and 21. The cover plates 24 and 25 are slides, which have measuring apertures of different size diameters. By moving the cover plates 24 and 25 in horizontal direction the measuring apertures for the detectors 20 and 21 can be changed. So e.g. the sample plates for 24 or 96 sample wells can be measured.

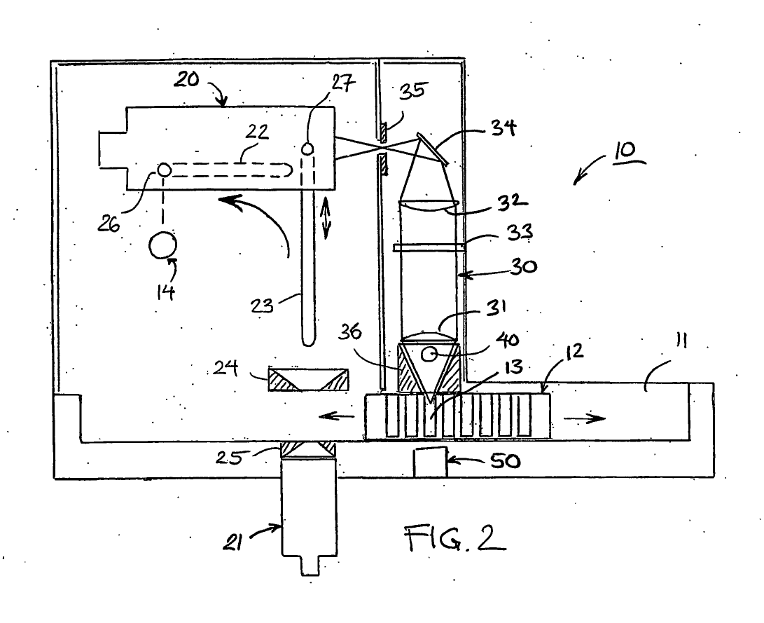

In the multifunction instrument 10 of FIG. 1 the first photo multiplier tube 20 is presented in its first position for liquid scintillation counting and/or luminescence counting of the sample plate 12. For turning the photo multiplier tube 20 into the second position the tube 20 is provided with a slide pin 26 moving in a guide track 22. Then a rotating device 14 turns the detector anticlockwise the second measuring position described in FIG. 2.

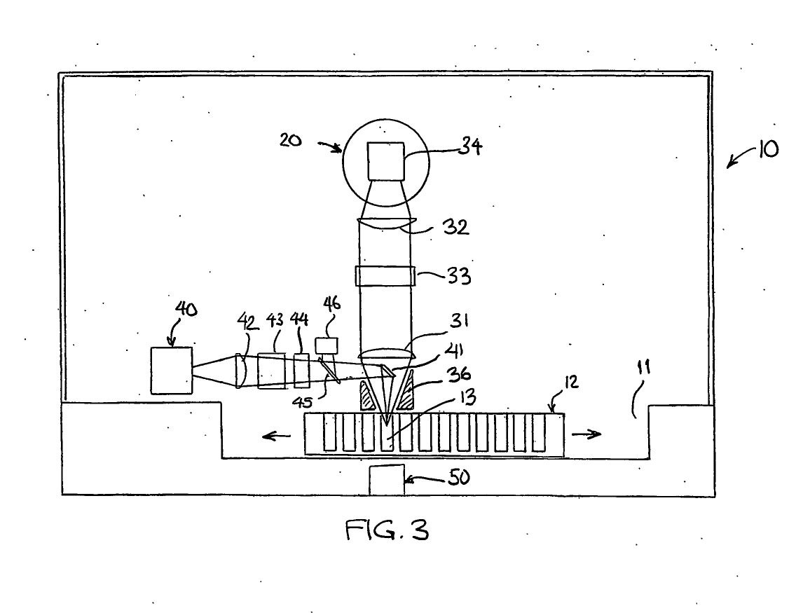

In FIG. 2 the multifunction instrument 10 is presented in the second measuring position. In that position the first photo multiplier tube 20, locating above the sample well 13, has been rotated counterclockwise by a rotating device 14. In this position the same photo multiplier tube 20 can be used as a detector for fluorescence measuring. For this measurement the sample plate 12 and the sample well 13 to be measured has been moved to another location adjacent to the light path system 30. The excitation light is brought to the sample well 13 by the excitation light system 40, which is more detailed described in FIG. 3. In the fluorescence measuring of FIG. 2 the emitted light from the sample well 13 of the sample plate 12 is directed through the lenses 31, 32 and filter 33 to the mirror 34, where the light is reflected to the detector photo multiplier tube 20.

FIG. 3 shows the multifunction instrument 10 of FIG. 2 seen from another side. The measuring process is the fluorescence measuring as described in FIG. 2. The excitation light is brought from the excitation light source 40 through a lens 42 and filters 43 and 44 via a mirror 41 to the sample well 13 of the sample plate 12. The emitted light from the sample well 13 is directed through the lenses 31, 32 and filter 33 to the mirror 34 and reflected to the photo multiplier tube 20, as already described in FIG. 2. The excitation light mirror 41 is essentially smaller than the lens 31 in the emission light path. The ratio of the areas of the mirror 41 and lens 31 is about 1:40. In the excitation light path there is also a second mirror 45 for bringing light to a reference detector 46.

In the multifunction instrument 10 of FIG. 3 there is also a cover plate 36 slide, which has apertures of different size diameters. By moving the cover plate 36 in horizontal direction an appropriate measuring aperture can be selected. So e.g. the sample plates for 96 sample wells or more can be measured.

The multifunction instrument 10 of FIG. 3 is also provided with an absorbance detector 50 below the sample plate 12, which can be used with the said light source 40. Also on the opposite side of the excitation light source 40 there is space for some other optional measuring detector.

It is obvious to a person skilled in the art that the different embodiments of the invention may vary within the scope of the claims presented below.

### REFERENCE NUMERALS

10 multifunction instrument
11 transfer unit
12 sample plate
13 well
14 rotating device
20 photo multiplier tube
21 photo multiplier tube
22 guide track
23 guide track
24 cover plate
25 cover plate
26 slide pin
27 slide pin
30 light path system
31 lens
32 lens
33 filter
34 mirror
35 aperture plate
36 cover plate
40 excitation light source
41 mirror
42 lens
43 filter
44 filter
45 mirror
46 reference detector
50 absorbance detector

1. A multifunction instrument for measuring biochemical and medical samples, which are preferably placed into wells of sample plates and measured by a detector, the instrument having means for moving the detector into two different positions for using at least two different light paths for measuring the samples, characterized in that the multifunction instrument is provided with a device for moving the detector into the following two different positions for two different light paths :
in the first position for measuring radioactive labels by liquid scintillation counting the detector (20) is placed close to the sample or sample well for receiving signals via the first light path without any light conducting components between the detector and the sample,
and in the second position for non-radioactive measuring, such as fluorescence measuring the detector is arranged to receive emitted light from the sample via the second light path, where is at least one optical component, between the detector and the sample.

2. The multifunction instrument as claimed in claim 1, characterized in that the multifunction instrument is provided with a rotating device for rotating the detector in two different positions for the said two different light paths.

3. The multifunction instrument as claimed in claim 1, characterized in that in the first position of the detector the first light path is provided for liquid scintillation counting and/or luminescence counting.

4. The multifunction instrument as claimed in claim 1, characterized in that in the second position of the detector the multifunction instrument has a light source provided for excitation light with the second light path for fluorescence measuring.

5. The multifunction instrument as claimed in claim 1, characterized in that the multifunction instrument is provided with an absorbance detector to be used with the light source.

6. The multifunction instrument as claimed in claim 1, characterized in that
detector is provided with slide and guide elements for turning the detector into the said two positions,
the rotating device is provided to turn the detector into the first position or the vertical position for liquid scintillation measuring and/or luminescence counting above the sample plate,
and the rotating device is provided to turn the detector into the second position or the horizontal position for fluorescence measuring via the second light path.

7. The multifunction instrument as claimed in claim 1, characterized in that the vertical first position of the detector the detector is used for liquid scintillation counting and placed above the sample well without any intermediate components.

8. The multifunction instrument as claimed in claim 1, characterized in that in the vertical first position a cover plate provided with an aperture is placed between the detector (20) and the sample well for guiding the light from the sample through the aperture to the detector.

9. The multifunction instrument as claimed in claim 8, characterized in that
the cover plate is a slide element provided with at least two apertures of different size diameter,
and the slide element can be moved in horizontal direction for placing any of the apertures above the sample well to be measured.

10. The multifunction instrument as claimed in claim 8, characterized in that at least one aperture in the slide element is funnel shaped so that the aperture end of smaller diameter facing the sample well substantially fits the size of the diameter of the sample well.

11. The multifunction instrument as claimed in claim 2, characterized in that in the first position of the detector the first light path is provided for liquid scintillation counting and/or luminescence counting.
